(19) United States
(12) Patent Application Publication
(10) Pub. No.: US 2007/0273295 A1
(43) Pub. Date: Nov. 29, 2007

(54) ELECTRO-OPTICAL DEVICE AND IMAGE FORMING APPARATUS

(75) Inventors: Junichi WAKABAYASHI, Fujimi-machi (JP); Tokuro OZAWA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/753,349

(22) Filed: May 24, 2007

(30) Foreign Application Priority Data
May 26, 2006 (JP) 2006-146431

(51) Int. Cl. G09G 3/10; H04J 14/08

(52) U.S. Cl. 315/169.3; 398/101

(57) ABSTRACT

An electro-optical device includes a first electro-optical element, a second electro-optical element, and a third electro-optical element. A first node is electrically connected to the first electro-optical element, a second node is electrically connected to the second electro-optical element, and a third node electrically connected to the third electro-optical element. A first resistor placed between the first node and the third node and a second resistor placed between the second node and the third node. Additionally, a first signal supplying unit that supplies a first signal to the first node and a second signal supplying unit that supplies a second signal to the second node.

### CROSS-REFERENCE TO RELATED APPLICATION

This application claims priority from Japanese Patent Application No. 2006-146431 filed in the Japanese Patent Office on May 26, 2006, the entire disclosure of which is hereby incorporated by reference in its entirety.

### BACKGROUND

1. Technical Field

Embodiments of the present invention include techniques for controlling tone levels of electro-optical elements, such as organic light-emitting diodes or the like.

2. Related Art

Electro-optical devices having an arrangement of electro-optical elements, such as organic light-emitting diodes or the like, are widely used in electronic apparatuses, such as image forming apparatuses and display apparatuses. For example, JP-A-2006-62162 discloses a light-emitting device in which a drive circuit is mounted on a surface of a substrate having an arrangement of many electro-optical elements. The tone level of each electro-optical element is controlled in accordance with a signal supplied thereto from the drive circuit.

In such an electro-optical device, the electro-optical elements are expected to provide higher resolution. However, the number of signal input sources of the drive circuit to input signals to the electro-optical elements must be increased to enable the electro-optical elements to provide higher resolution. As a result, the dimensions of the drive circuit are increased, and hence, the size of the electro-optical device is increased. In contrast, a reduction in the dimensions of the drive circuit degrades the resolution of the electro-optical elements.

### SUMMARY

Embodiments of the invention improve the resolution of electro-optical elements while reducing the dimensions of a drive circuit that drives the electro-optical elements.

According embodiments, there is provided an electro-optical device including the following elements: a first electro-optical element (e.g., an electro-optical element EL shown in FIG. 3), a second electro-optical element (e.g., an electro-optical element ER), and a third electro-optical element (e.g., an electro-optical element EM); a first node (e.g., a node b1) electrically connected to the first electro-optical element; a second node (e.g., a node b2) electrically connected to the second electro-optical element; a third node (e.g., a node b3) electrically connected to the third electro-optical element; a first resistor (e.g., a resistor R1) placed between the first node and the third node; a second resistor (e.g., a second resistor R2) placed between the second node and the third node; a first signal supplying unit (e.g., a variable voltage source 33L) that supplies a first signal (signal corresponding to a tone level specified to the first electro-optical element) to the first node; and a second signal supplying unit (e.g., a variable voltage source 33R) that supplies a second signal (signal corresponding to a tone level specified to the second electro-optical element) to the second node.

In the electro-optical device described above, the first electro-optical element is driven by the signal supplied from the first signal supplying unit, and the second electro-optical element is driven by the signal supplied from the second signal supplying unit. The third electro-optical element is driven by a voltage or a current determined on the basis of the signals supplied from the first signal supplying unit and the second signal supplying unit and the resistances of the first resistor and the second resistor. Compared with a known structure in which the same number of signal supplying units as the number of electro-optical elements are necessary, the definition or resolution of the electro-optical elements can be improved while suppressing an increase in the number of signal supplying units (an increase in the dimensions of a drive circuit).

The electro-optical elements according to embodiments of the invention are elements whose optical characteristics, such as brightness or light transmittance, change in response to application of electrical energy (e.g., current supply or voltage application). Specific examples of the electro-optical elements include light-emitting elements (e.g., electroluminescent elements and plasma display elements) that emit light in response to application of electrical energy, and light modulation elements (e.g., liquid crystal elements and electrophoretic elements) whose light transmittance changes in response to application of electrical energy. The specifics of the first resistor and the second resistor are disregarded. For example, switching elements (non-linear resistance elements) such as thin-film transistors (TFTs) may serve as the first resistor and the second resistor.

The first signal and the second signal according to embodiments of the invention may be voltage signals or current signals. Therefore, the first signal supplying unit and the second signal supplying unit may be either variable voltage sources or variable current sources. In the case that voltage signals are used (the tone levels of the electro-optical elements are controlled by changing voltages at the nodes), the electro-optical device includes the following elements: a first electro-optical element, a second electro-optical element, and a third electro-optical element; a first node that supplies a first voltage signal to the first electro-optical element; a second node that supplies a second voltage signal to the second electro-optical element; and a third node placed between the first node and the second node, the third node dividing and supplying the first voltage signal and the second voltage signal to the third electro-optical element. In the case that current signals are used (the tone levels of the electro-optical elements are controlled by changing currents supplied to the nodes), the electro-optical device includes the following elements: a first electro-optical element, a second electro-optical element, and a third electro-optical element; a first node that supplies a first current signal to the first electro-optical element; a second node that supplies a second current signal to the second electro-optical element; and a third node placed between the first node and the second node, the third node supplying a shunt current of each of the first current signal and the second current signal to the third electro-optical element.

Needless to say, the structure in which another electro-optical element in addition to the third electro-optical element is connected to a path connecting the first node to the second node (that is, the structure in which at least two electro-optical elements are connected between the first node and the second node) is included in the scope of the invention. For example, the first resistor placed between the first node (e.g., a node b1 shown in FIG. 10) and the third node (e.g., a node b3 shown in FIG. 10) may serve as a plurality of resistors connected in series (e.g., a resistor R between the node b1 and a node b4 and another resistor R between the node b3 and the node b4), and an additional electro-optical element may be connected between the resistors (the third node is regarded as one of the nodes b3, b4, and b5 shown in FIG. 10). With this structure, more than three electro-optical elements are driven by two signal supplying units, and hence the above-described advantages become more striking.

It is preferable that the first electro-optical element and the second electro-optical element be placed sandwiching the third electro-optical element. With this structure the tone level of the third electro-optical element is controlled in accordance with the tone levels of the first and second electro-optical elements adjacent to the third electro-optical element. Accordingly, the tone level in an area covering the first to third electro-optical elements can be changed in a natural manner.

In contrast, in the case that an image containing sentences or diagrams (hereinafter referred to as a “data image”) is processed, it is preferable that the shades of tones be clearly distinguished. It is preferable that, in the case that a lowest tone level (e.g., the tone level “0” shown in FIG. 2A) is specified to the first electro-optical element and that a higher tone level (e.g., the tone level “7”) is specified to the second electro-optical element, the first signal supplying unit selectively supply one of a voltage (e.g., V[0]) or current allowing the third electro-optical element to provide a tone level between the tone levels of the first and second electro-optical elements and a voltage (e.g., Va[0]) or current allowing the third electro-optical element to provide the lowest tone level to the first node. In the case that an image to be processed is a data image, a voltage or current that allows the third electro-optical element to provide the lowest tone level is applied to the first electro-optical element to which the lowest tone level is specified. In this way, the image quality suitable for not only a natural image but also a data image can be achieved. A specific example of this aspect will be described later as a second embodiment.

According to some embodiments, there is provided an electro-optical device including the following elements: a continuous electrode including a first node and a second node, the first node and the second node are separated from each other; a first signal supplying unit that supplies a first signal to the first node; a second signal supplying unit that supplies a second signal to the second node, the second signal being set independent of the first signal; and an electro-optical layer that provides a tone level according to a voltage or current distribution in a plane of the electrode. In the electro-optical device, the electrode including the first node and the second node to which drive signals are supplied is continuous across the two nodes. In an area between the two nodes, a voltage or current distribution changes continuously according to the potential difference or current difference between the first signal and the second signal and the resistance of the electrode. Therefore, the tone level of the electro-optical layer changes continuously. Compared with the structure in which the first node and the second node are disposed on separate electrodes, a high-resolution, multiple-tone image can be represented without increasing the number of signal supplying units. A specific example of this aspect will be described later as a third embodiment.

It is preferable that the electro-optical device further include the following elements: a first terminal placed on a substrate and electrically connected to the first node; a second terminal placed on the substrate and electrically connected to the second node; and an electronic component mounted on the substrate, the electronic component including a first output terminal connected to the first terminal and a second output terminal connected to the second terminal, wherein the signal from the first signal supplying unit is input to the first output terminal, and the signal from the second signal supplying unit is input to the second output terminal. The electronic component is, for example, an integrated circuit (IC) chip (e.g., an IC chip 30 shown in FIG. 1) mounted on the substrate of the electro-optical device using a chip on glass (COG) technique. In this case, the first terminal and the second terminal (e.g., mounting terminals 31) are disposed at positions on a surface of the substrate (e.g., a substrate 10) facing the first output terminal and the second output terminal of the IC chip. Another example of the electronic component is a flexible substrate (e.g., a flexible substrate 50) on which the IC chip is mounted using a chip on film (COF) technique. Since the flexible substrate is mounted on the substrate, the first terminal and the second terminal are disposed at positions on the surface of the substrate facing the first output terminal and the second output terminal of the flexible substrate.

If the size of the terminals (the first terminal and the second terminal) on the substrate is excessively reduced, a connection failure is more likely to occur between the terminals and the output terminals of the electronic component. This puts a limit to the degree of size reduction of the terminals. According to some embodiments, the electro-optical elements provide higher resolution while the number of terminals on the substrate is prevented from increasing. Therefore, the resolution of an image can be increased while maintaining the reliability of connection between the terminals on the substrate and the output terminals of the electronic component. According to embodiments of the invention, the number of mounting terminals relative to the same number of electro-optical elements is reduced. In the case that each electronic component having the same number of output terminals as the known structure is used, the number of electronic components necessary for driving the same number of electro-optical elements as the known structure is reduced, thereby reducing the cost. Since the number of electronic components is reduced, the device becomes smaller.

The electro-optical device according to embodiments of the invention can be used in various electronic apparatuses. A typical example of an electronic apparatus is an image forming apparatus that uses the electro-optical device to expose an image supporting member, such as a photosensitive drum. The electro-optical device having a matrix of electro-optical elements may be used as a display device of various electronic apparatuses, such as a personal computer and a cellular phone. In an image scanning apparatus such as a scanner, the electro-optical device according to embodiments of the invention may be used to illuminate a document. The image scanning apparatus includes the electro-optical device according to embodiments of the invention and a light receiving device (such as a charged coupled device (CCD)) that converts light emitted from the electro-optical device and reflected from an object to be scanned (e.g., the document) into an electrical signal.

### BRIEF DESCRIPTION OF THE DRAWINGS

Embodiments of the invention will be described with reference to the accompanying drawings, wherein like numbers reference like elements.

FIG. 1 is a plan view of an exemplary structure of an electro-optical device according to a first embodiment of the invention.

FIG. 2A is a graph showing voltage-current characteristics of each electro-optical element according to embodiments of the invention, and FIG. 2B is a graph showing current-light intensity characteristics of each electro-optical element.

FIG. 3 is a circuit diagram of the electrical structure of an element group and an IC chip.

FIG. 4 is a table showing the relationship among tone levels of the electro-optical elements.

FIGS. 5A to 5E are schematic diagrams of the tone levels of the electro-optical elements.

FIG. 6 is a diagram showing the relationship between the density of hatched portions shown in FIGS. 5A to 5E and the tone level of each electro-optical element.

FIG. 7 includes diagrams for describing advantages of the first embodiment.

FIG. 8 includes diagrams for describing a method of driving the electro-optical device according to a third embodiment of the invention.

FIG. 9 is a diagram for describing another method of driving the electro-optical device according to the third embodiment.

FIG. 10 is a circuit diagram of the electrical structure of an element group according to a modification.

FIG. 11 is a circuit diagram of the electrical structure of an element group according to another modification.

FIG. 12 is a diagram showing an exemplary image forming apparatus using electro-optical devices.

### DESCRIPTION OF EXEMPLARY EMBODIMENTS

### A. First Embodiment

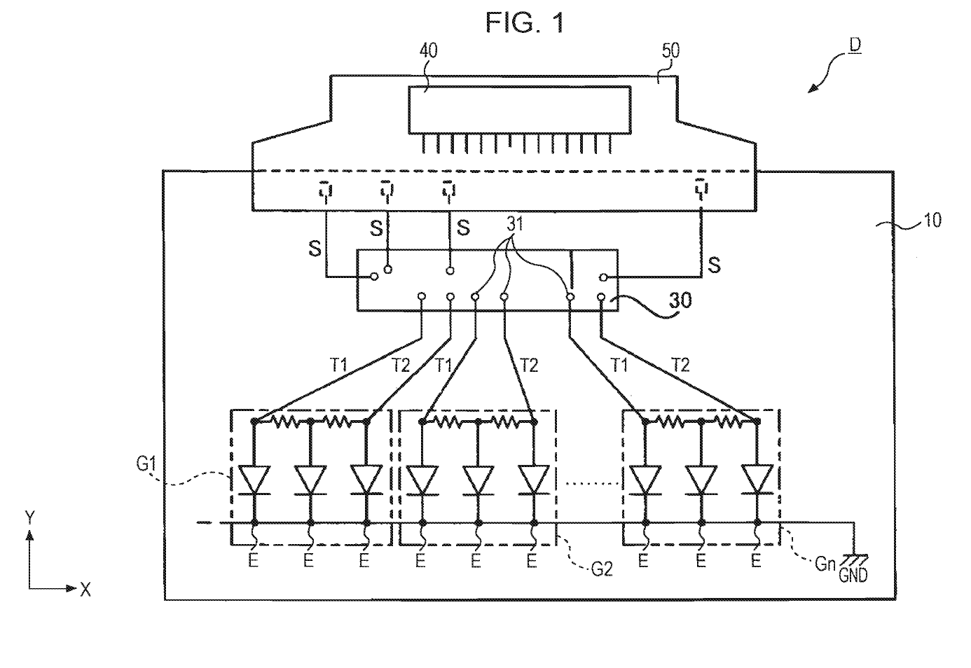

FIG. 1 is a plan view of an exemplary structure of an electro-optical device D according to a first embodiment of the invention. The electro-optical device D is used, for example, as an exposure device for forming a latent image on a photosensitive member in an electrophotographic image forming apparatus. As shown in FIG. 1, the electro-optical device D has a substrate 10 and a plurality of electro-optical elements E formed on a surface of the substrate 10. The electro-optical elements E are arranged in two lines along the X-direction (main scanning direction) in a zigzag pattern. The electro-optical elements E according to the first embodiment are organic light-emitting diodes, each having a light-emitting layer made of an organic electroluminescent (EL) material and an anode and a cathode sandwiching the light-emitting layer. Each of the electro-optical elements E emits light with brightness according to current supplied to the light-emitting layer. The electro-optical elements E are organized into n element groups G (G1, G2, . . . , and Gn) of three adjacent elements (where n is a natural number).

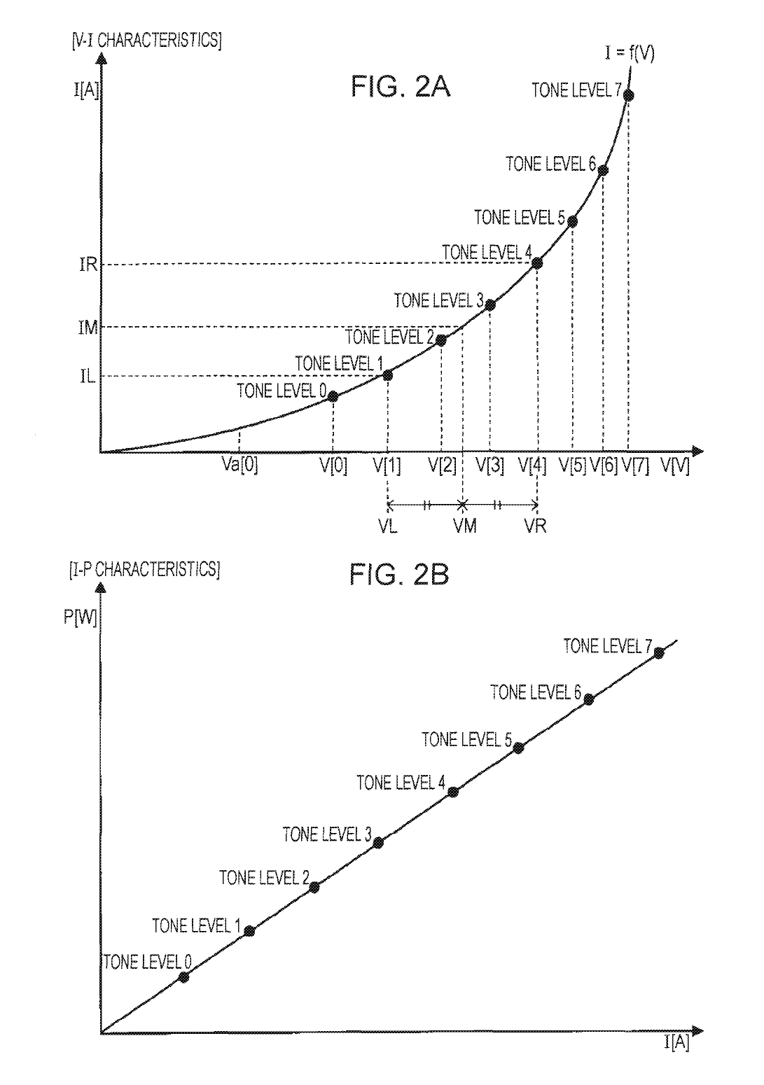

FIG. 2A is a graph showing voltage-current (V-I) characteristics of each electro-optical element E. FIG. 2B is a graph showing current-light intensity (I-P) characteristics of each electro-optical element E. As shown in FIG. 2A, the amount of current flowing through the electro-optical element E changes nonlinearly relative to the voltage value of a voltage between the anode and the cathode (hereinafter referred to as a “drive voltage”). As shown in FIG. 2B, the electro-optical element E emits light with an intensity proportional to the amount of current flowing therethrough. As shown in FIGS. 2A and 2B, according to the first embodiment, one of eight tone levels “0” to “7” is specified from the outside to each of the electro-optical element E.

Referring back to FIG. 1, an IC chip 30 and a flexible substrate 50 are mounted on the substrate 10 using, for example, a COG technique. The flexible substrate 50 is provided with a controller 40. The IC chip 30 generates and outputs drive voltages according to control signals supplied from the controller 40 via lines S. Although only one flexible substrate 50 and one IC chip 30 are shown in FIG. 1 by way of example, many flexible substrates 50 and many IC chips 30 are actually mounted on the substrate 10.

A pair of a line T1 and a line T2 is provided for each element group G on the surface of the substrate 10 (that is, a total of n pairs are provided). The lines T1 and T2 are lines from ends facing output terminals of the IC chip 30 (hereinafter referred to as “mounting terminals”) to the element groups. The mounting terminals are connected to the corresponding output terminals of the IC chip 30.

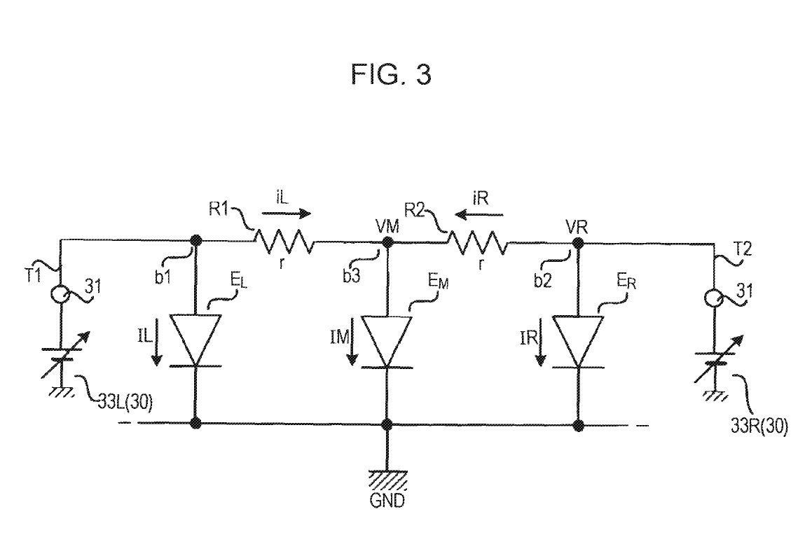

FIG. 3 is a circuit diagram of the electrical structure of an element group Gi (i is an integer satisfying 1≦i≦n) and the IC chip 30. As shown in FIG. 3, the element group Gi includes electro-optical elements EL and ER and an electro-optical element EM placed therebetween. The line T1 is connected from the mounting terminal 31 via a node b1 to the anode of the electro-optical element EL. The line T2 is connected from the mounting terminal 31 via a node b2 to the anode of the electro-optical element ER.

The node b1 and the node b2 are electrically connected to each other. A node b3 placed on a line connecting the node b1 to the node b2 is connected to the anode of the electro-optical element EM. A resistor R1 is placed on a path connecting the node b1 to the node b3. A resistor R2 is placed on a path connecting the node b2 to the node b3. The resistor R1 and the resistor R2 have the equal resistance r. The cathodes of the electro-optical elements EL, EM, and ER are connected to a common constant voltage source GND. In this manner, the electro-optical elements EL, EM, and ER are connected parallel to one another.

As shown in FIG. 3, the IC chip 30 has variable voltage sources 33L and 33R, the number of which corresponds to the total number (2n) of the lines T1 and T2. The variable voltage source 33L outputs a drive voltage VL having a voltage value (one of V[0] to V[7] shown in FIG. 2A) according to the tone level specified to the electro-optical element EL. The drive voltage VL is applied from the output terminal of the IC chip 30 via the mounting terminal 31 and the line T1 (node b1) to the anode of the electro-optical element EL. Thus, the electro-optical element EL is controlled to provide a tone level according to the drive voltage VL (current IL) (that is, the electro-optical element EL emits light with brightness according to the drive voltage VL). Similarly, the variable voltage source 33R outputs a drive voltage VR having a voltage value (one of V[0] to V[7] shown in FIG. 2A) according to the tone level specified to the electro-optical element ER. The drive voltage VR is applied via the mounting terminal 31 and the line T2 (node b2) to the anode of the electro-optical element ER. Thus, the electro-optical element ER is controlled to provide a tone level according to the drive voltage VR (current IR).

In contrast, a drive voltage VM determined on the basis of the drive voltage VL applied to the node b1, the drive voltage VR applied to the node b2, and the resistance r of the resistors R1 and R2 is applied to the electro-optical element EM. In this manner, whereas the tone levels of the electro-optical elements EL and ER are directly controlled according to the voltage values of the drive voltages VL and VR, respectively, the tone level of the electro-optical element EM is determined relative to the voltage values of the drive voltages VL and MR. Thus, even though only two electro-optical elements (EL and ER) are directly driven by the variable voltage sources 33, three electro-optical elements including the electro-optical element EM are driven as if their tone levels were individually controlled. That is, according to the first embodiment, the resolution of all image output from the image forming apparatus can be improved in a pseudo manner. The voltage applied to the electro-optical element EM will be described in detail below.

In the example shown in FIG. 3, when (GND<VL<VR, the drive voltage VM is computed as:

VM=VL−iL×r=VR−iR×r (1)

where “iL” is a current flowing through the resistor R1, and “iR” is a current flowing through the resistor R2. A current IM flowing through the electro-optical element EM is the current value of the sum of the current iL and the current iR (IM=iL+iR).

As is clear from equation (1), when the drive voltages VL and VR with different voltage values are given, the drive voltage VM has a voltage value between the drive voltages VL and VM (median of the drive voltages VL and VR). Therefore, the electro-optical element EM is controlled to provide a tone level (intermediate tone level) between the tone levels of the electro-optical elements EL and ER. Since the tone levels of adjacent pixels in an image are often similar, such a control scheme can allow the electro-optical element EM to provide a natural tone level relative to the electro-optical elements EL, and ER.

At the same time, voltage drops occur across the resistors R1 and R2. In the case that the drive voltages VL and VR are equal (the same tone level is specified to both the electro-optical elements EL and ER), the drive voltage VM has a voltage value lower than that of the drive voltages VL and VR. Thus, the electro-optical element EM provides a lower tone level than that of the electro-optical elements EL and ER. However, an image becomes unnatural in the case that the tone level of the electro-optical element EM is significantly different from the tone levels of the electro-optical elements EL and ER. According to the first embodiment, in the case that the tone levels of the electro-optical elements EL and ER are equal, the resistance r is set such that the tone level of the electro-optical element EM becomes substantially visually equal to that of the electro-optical elements EL and ER. For example, in the case that the tone level “7” is specified to the electro-optical elements EL and ER, the resistance r is determined such that the electro-optical element EM provides the tone level “6.5”. In this case, the resistance r is computed using equation (1) as:

V[7]−V[6.5]=I[6.5]×r/2 (2)

where the voltage V[7] is a voltage applied to one electro-optical element E such that the electro-optical element E is controlled to provide the tone level “7”, and the voltage v[6.5] is a voltage applied to one electro-optical element E such that the electro-optical element E is controlled to provide the tone level [6.5]. The current I[6.5] is a current supplied to one electro-optical element E such that the electro-optical element E is controlled to provide the tone level “6.5”. By setting the resistance r in this manner, the electro-optical element EM is prevented from providing a significantly low tone level compared with the left and right electro-optical elements EL and ER (that is, a tone level difference among the adjacent elements is prevented from becoming striking). According to the first embodiment, the resistance r=22 kΩ is set as a design value.

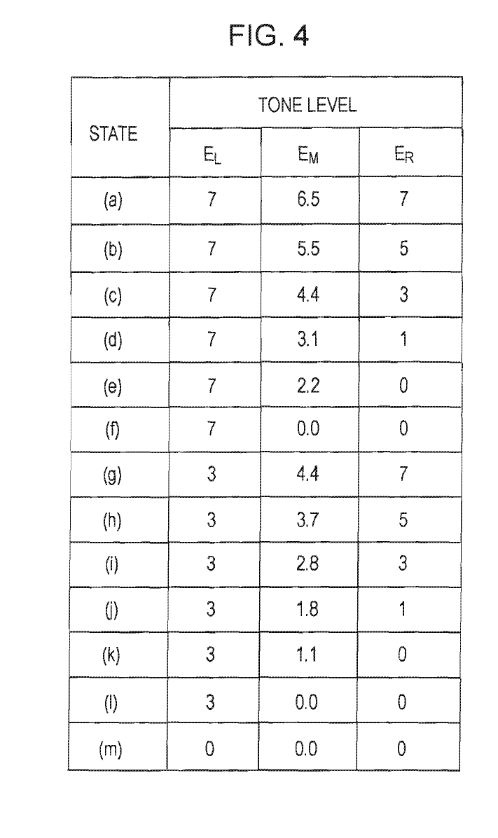

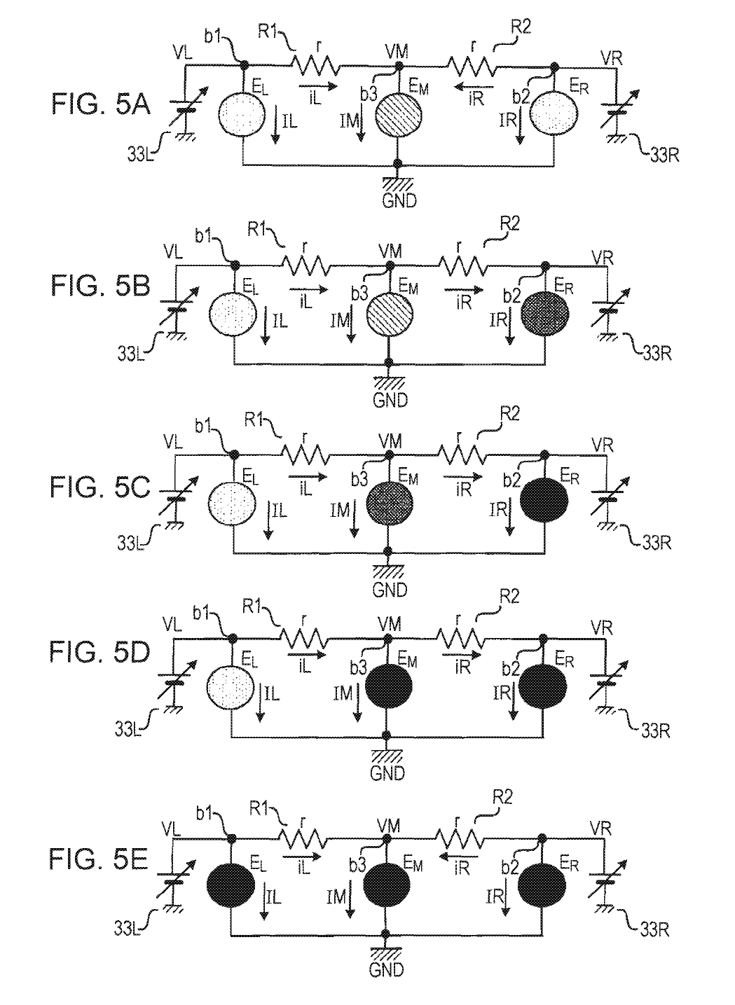

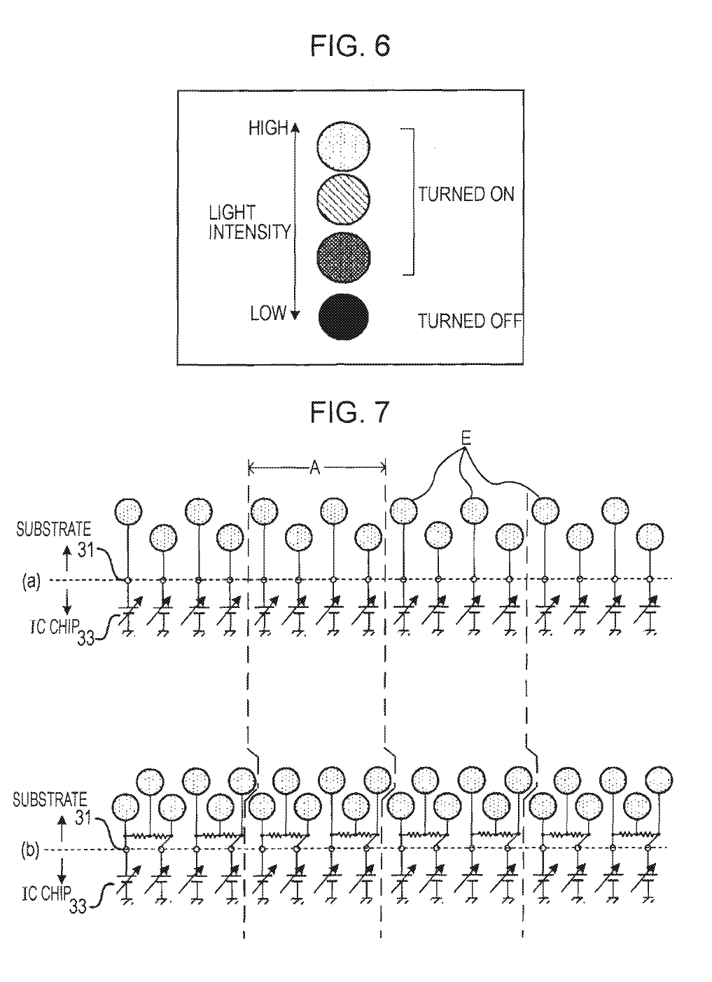

FIG. 4 is a table showing the relationship among the tone levels of the electro-optical elements EL and ER and the tone level of the electro-optical element EM. As shown in FIG. 4, one of “7”, “3”, and “0” is specified to the tone level of the electro-optical element EL. FIGS. 5A to 5E are schematic diagrams showing the tone levels of the electro-optical elements EL, EM, and ER. FIG. 6 shows the relationship between the density of hatched portions in FIGS. 5A to 5E and the light intensity (tone level) of each electro-optical element E.

When the tone level “7” is specified to both the electro-optical elements EL and ER, both the drive voltages VL and VR are set to the voltage value v[7]. Therefore, as shown in state (a) of FIG. 4, both the electro-optical elements EL and ER provide the tone level “7”. In this state, as shown in FIG. 5A, the sum (IM) of the current iL flowing from the node b1 to the node b3 and the current iR flowing from the node b2 to the node b3 flows through the electro-optical element EM. Accordingly, the drive voltage VM that is lower than the voltage value V[7] is applied to the electro-optical element EM. As shown in state (a) of FIG. 4 and FIG. 5A, the electro-optical element EM provides the tone level “6.5”, which is lower than that of the electro-optical elements EL and ER. Similarly, as shown in state (i) of FIG. 4, in the case that the tone level “3” is specified to both the electro-optical elements EL and ER, the drive voltage VM that is lower than the voltage value V[3] is applied to the electro-optical element EM, and hence the electro-optical element EM provides the tone level “2.8”, which is lower than the tone level “3”.

In states (b) to (d) shown in FIG. 4, the tone level “7” is specified to the electro-optical element EL, and a tone level (1, 3, or 5) lower than the tone level “7” is specified to the electro-optical element ER. In these cases, the drive voltage VL is set to the voltage value V[7], and the drive voltage VR is set to a voltage value (V[ ], V[3], or V[5]) lower than the voltage value V[7]. Accordingly, as shown in FIG. 5B, current flows from the node b1 to the node b2. The drive voltage VM thus becomes a voltage value between the drive voltages VL and VR. As shown in FIG. 5B, the electro-optical element EM provides a tone level between those of the electro-optical elements EL and ER. Also in states (g), (h), and (j) shown in FIG. 4, the drive voltage VL is different from the drive voltage VR. Therefore, as shown in FIG. 5B, the electro-optical element EM provides a tone level between those of the electro-optical elements EL and ER.

As shown in states (e) and (k) of FIG. 4, in the case that the tone level “0” is specified to the electro-optical element ER, the drive voltage VR is set to the voltage value V[0]. Accordingly, as shown in FIG. 5C, the electro-optical element ER is turned off (the tone level “0”), and the electro-optical element EM provides a tone level between those of the electro-optical elements EL and ER, as in FIG. 5B.

As shown in state (m) of FIG. 4, in the case that the tone level “0” is specified to both the electro-optical elements EL and ER, both the drive voltages VL and VR are set to the voltage value V[0]. In this case, the drive voltage VM is lower than the voltage value V[0]. As shown in FIG. 5E, all of the electro-optical elements EL, EM, and ER are turned off. States (f) and (l) will be described later in the next embodiment.

As has been described above, in the case that the same tone level is specified to both the electro-optical elements EL and ER, the tone level of the electro-optical element EM is slightly lower than or substantially equal to the tone level of the left and right electro-optical elements EL and ER. In the case that different tone levels are specified to the electro-optical elements EL and ER, the tone level of the electro-optical element EM is between those of the electro-optical elements EL and ER. Therefore, according to the electro-optical device D of the first embodiment, tone level characteristics suitable for the case in which, as in a photograph, a natural image in which the tone level changes step by step in most of the image can be achieved.

FIG. 7 includes diagrams for describing advantages of the first embodiment. Portion (a) of FIG. 7 is a schematic diagram showing the structure of a known electro-optical device in which one electro-optical element E is driven by one variable voltage source 33 (that is, one variable voltage source 33 is disposed for each electro-optical element E). As shown in portion (a) of FIG. 7, the known electro-optical device has four electro-optical elements E in each unit area A indicated by broken lines.

In contrast, portion (b) of FIG. 7 is a schematic diagram showing the structure of the first embodiment in which three electro-optical elements E are driven by two variable voltage sources 33. The number of variable voltage sources 33 (the number of mounting terminals 31) is the same in the structure shown in portion (a) of FIG. 7 and the structure shown in portion (b) of FIG. 7. As shown in portion (b) of FIG. 7, according to the first embodiment, six electro-optical elements E can be placed in each unit area A similar to that of portion (a) of FIG. 7. In this manner, according to the electro-optical device D of the first embodiment, the density of the electro-optical elements E can be increased (1.5 times) while the circuit dimensions of the IC chip 30 (density of the mounting terminals 31) is maintained at a level equivalent to that in the structure shown in portion (a) of FIG. 7. That is, while the known structure provides a resolution of 600 dpi, for example, a drive method according to the first embodiment can achieve a high resolution of 900 dpi using the same number of variable voltage sources 33.

If the size of the mounting terminals 31 is excessively reduced, a connection failure may occur between the output terminals of the IC chip 30 and the corresponding mounting terminals 31. In addition, high alignment accuracy is required to mount the IC chip 30 onto the substrate 10 (to connect the output terminals of the IC chip 30 to the corresponding mounting terminals 31). According to the first embodiment, the resolution of the electro-optical elements E can be improved without increasing the number of the mounting terminals 31. Even when reduction in size of the mounting terminals 31 is limited in order to guarantee reliability of connection between the IC chip 30 and the mounting terminals 31, the resolution of the electro-optical elements E can be improved.

From a different point of view, according to the electro-optical device D of the first embodiment, the total number of the mounting terminals 31 required for driving a predetermined number of electro-optical elements E is reduced. Thus, in the case that each IC chip 30 having the same number of output terminals as a known IC chip is used, the number of IC chips 30 required for driving the same number of electro-optical elements E as that of a known electro-optical device and the number of flexible substrates 50 are reduced, thereby reducing the cost. For example, assume that a known electro-optical device has 7200 electro-optical elements E, which are driven by fifteen IC chips 30 (one IC chip drives 480 electro-optical elements E). According to the electro-optical device D of the first embodiment, one IC chip 30 can drive 720 electro-optical elements E. The number of IC chips 30 required for driving 7200 electro-optical elements E is reduced to ten.

Furthermore, as the number of the mounting terminals 31 is reduced, so is the number of lines connecting the mounting terminals 31 to the electro-optical elements E. Accordingly, a space occupied by the lines on the substrate 10 is reduced, thereby minimizing the device. With regard to the number of variable voltage sources 33, the number of drive power sources (variable voltage sources 33) required to achieve a predetermined resolution is reduced compared to the known structure, and hence the power consumption is reduced.

### B. Second Embodiment

In the first embodiment, in the case that different tone levels are specified to the electro-optical elements El and ER, the electro-optical element EM provides a tone level between those of the electro-optical elements EL and ER. Since the tone level in a natural image such as a photograph tends to change step by step, the above-described tone-level control scheme (e.g., the on/off states shown in FIG. 5C) is preferable. However, in the case of an image mainly including lines such as sentences and diagrams (hereinafter referred to as a “data image”), it is preferable that the shades of tones be clearly distinguished (e.g., the on/off states shown in FIG. 5D) in contrast to a natural image such as a photograph where the tone level tends to change continuously. According to a second embodiment, in the case that an image to be output (hereinafter referred to as an “output image”) is a data image, the voltage value of each drive voltage is set such that the boundary between areas with different tone levels is clear. Besides this point, the second embodiment is the same as the first embodiment described above. A description of the second embodiment is thus omitted where appropriate.

The IC chip 30 includes a circuit that determines whether an output image is a data image or a natural image (hereinafter referred to as an “image determination unit”). Various known techniques are adopted to determine the type of image. For example, the image determination unit determines that, in the case that the number of consecutive pixels having the same tone level in a predetermined area of the output image exceeds a threshold, the output image is a data image; in the case that the number of consecutive pixels having the same tone level falls below the threshold, the image determination unit determines that the output image is a natural image.

In the case that the output image is determined as a natural image, if the lowest tone level “0” is specified to the electro-optical element EL (ER), the variable voltage source 33L (33R) of the IC chip 30 generates and outputs the drive voltage VL (VR) having the voltage value V[0], as in the first embodiment. Since the voltage value of the drive voltage VM is a value between the drive voltages VL and VR, if the tone level “7” is specified to the electro-optical element EL and the tone level “0” is specified to the electro-optical element ER, for example as has been described with reference to FIG. 5C, the electro-optical element EM provides the tone level “2.2”, which is between the tone level “0” and the tone level “7” (state (e) shown in FIG. 4).

In contrast, in the case that the output image is determined as a data image, if the lowest tone level “0” is specified to the electro-optical element EL (ER), as shown in FIG. 2A, the variable voltage source 33L (33R) outputs the drive voltage VL (VR) set to a voltage value Va[0], which is lower than the voltage value V[0]. The voltage value Va[0] is set such that, in the case that one of the drive voltages VL and VR is set to the voltage value Va[0] and the other drive voltage is set to the voltage value V[7] corresponding to the highest tone level “7”, the drive voltage VM becomes less than or equal to the voltage value V[0]. With this structure, for example, in the case that the tone level “7” is specified to the electro-optical element EL and the tone level “0” is specified to the electro-optical element ER, as shown in FIG. 5D, the electro-optical element EM provides the lowest tone level “0”, together with the electro-optical element ER. In this manner, the data image in which an area with the tone level “7” is clearly distinguished from an area with the tone level “0” (there is no intermediate tone level area between the tone level “7” area and the tone level “0” area) can be displayed.

### C. Third Embodiment

In the first and second embodiments, the anodes of the electro-optical elements EL, EM, and ER are separated from one another. Alternatively, an anode may be continuous across a point at which the drive voltage VL is applied and a point at which the drive voltage VR is applied.

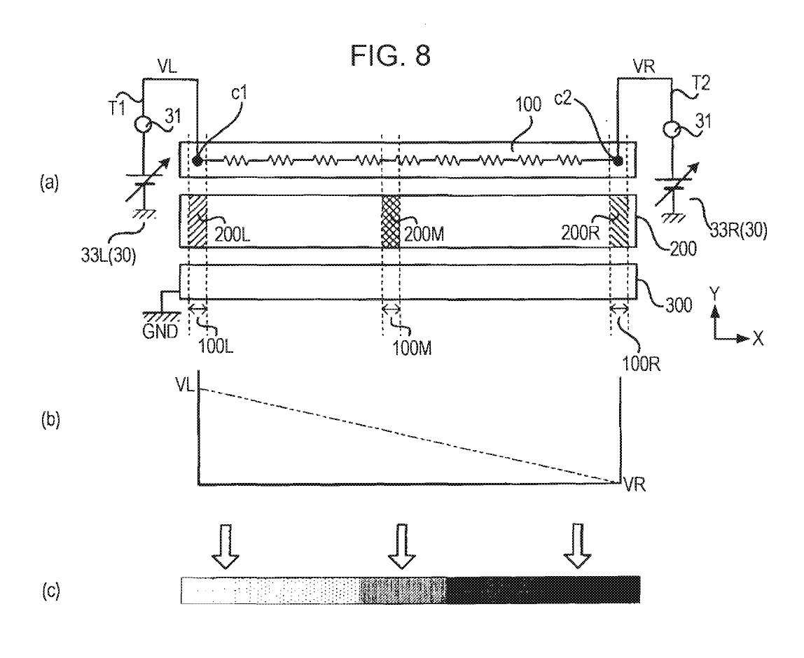

Portions (a) to (c) of FIG. 8 illustrate a drive method according to a third embodiment of the invention. Sections corresponding to those in the first embodiment are referred to using the same reference numerals, and descriptions thereof are omitted where appropriate.

As shown in portion (a) of FIG. 8, the electro-optical device D has an electro-optical layer (light-emitting layer) 200 made of an electro-optical material, such as an organic EL material, a cathode 300 continuous over the entire electro-optical layer 200, and a plurality of anodes 100 facing the cathode 300 with the electro-optical layer 200 provided therebetween. The anodes 100 are separated from one another. Only one anode 100 is shown in portion (a) of FIG. 8.

One anode 100 is continuous, including nodes c1 and c2. The line T1 is connected to the node c1. The drive voltage VL generated by the variable voltage source 33L is applied to the node c1 via the mounting terminal 31 and the line T1. Similarly, the drive voltage VR is applied from the variable voltage source 33R to the node c2 via the mounting terminal 31 and the terminal T2. A ground potential GND is applied to the cathode 300.

With this structure, the drive voltage VL is applied to an area 100L around the node c1 of the anode 100. Thus, an area (200L) of the electro-optical layer 200 overlapping the area 100L provides a tone level according to the drive voltage VL. Similarly, the drive voltage VR is applied to an area 100R around the node c2 of the anode 100. Thus, an area (200R) of the electro-optical layer 200 overlapping the area 100R emits light with brightness according to the drive voltage VR. In contrast, a voltage determined by the potential difference between the drive voltages VI and VR and a resistance r of the anode 100 is applied to an area (e.g., an area 100M) between the nodes c1 and c2 of the anode 100.

Portion (b) of FIG. 8 is a graph showing a distribution of voltages in the area between the nodes c1 and c2 of the anode 100 (when VL>VR=GND). Due to the resistance of the anode 100, a voltage drop occurs across the area between the nodes c1 and c2. Thus, as shown in portion (b) of FIG. 8, the voltage between the nodes c1 and c2 of the anode 100 changes linearly with a slope in accordance with the resistance r such that the voltage becomes closer to the drive voltage VL as the area between the nodes c1 and c2 becomes closer to the node c1, and the voltage becomes closer to the drive voltage VR as the area becomes closer to the node c2. For example, the voltage in the area 100M shown in portion (a) of FIG. 8 is about an intermediate value (median voltage value) between the drive voltages VL and VR.

Portion (c) of FIG. 8 shows tone levels of the electro-optical layer 200 in the case that the voltages shown in portion (b) of FIG. 8 are applied to the electro-optical layer 200. As shown in portions (a) and (c) of FIG. 8, the area 200L provides a high tone level. The closer to an area 200M, the lower the tone level. The tone level becomes zero in the area 200R. That is, an image in which the tone level changes smoothly from the node c1 to the node c2 is achieved. In the above description, it is assumed that the voltages in the areas 100L, 100M, and 100R are the same. Actually, however, the voltages in the areas 100L, 100M, and 100R are different due to voltage drops across these areas 100L, 100M, and 100R.

Although not shown in FIG. 8, in the case that VL=VR>GND, the voltage of the anode 100 is the lowest in the area 100M, which is located at the midpoint between the nodes c1 and c2. As a result, an image where the tone level becomes smaller from the areas (200L and 200R) corresponding to the nodes c1 and c2 of the electro-optical layer 200 to the center (i.e., the area 200M) in the X-direction is achieved.

As has been described above, according to the third embodiment, advantages similar to those of the first embodiment are achieved. In addition, the tone level of the electro-optical layer 200 changes continuously according to the voltage distribution of the anode 100 between the nodes c1 and c2. Compared with the case where three tone levels are obtained using two variable voltage sources 33L and 33R as in the first embodiment, an image with multiple tone levels can be achieved.

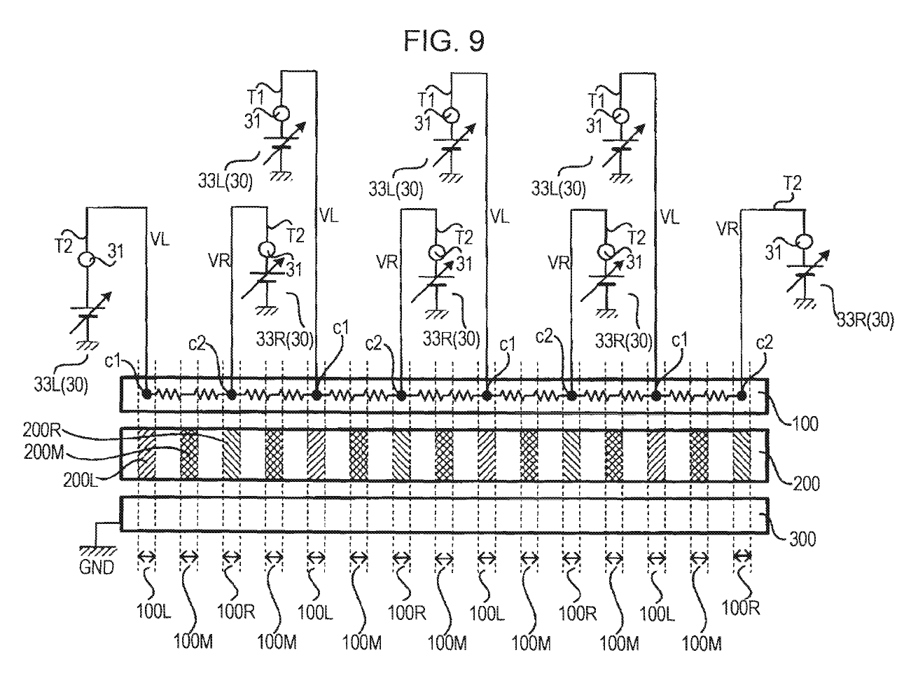

In FIG. 8, the structure in which multiple anodes 1100 are separated from one another has been described by way of example. The range where the anode 100 is continuous is changed as needed. For example, as shown in FIG. 9, a single anode 100 may be provided, which is continuous over the entire substrate 10. As shown in FIG. 9, the nodes c1 and c2 are alternately set at predetermined intervals in the in-plane direction of the anode 100. The drive voltage VL is applied to each node c1 from a corresponding one of the variable voltage sources 33L via the mounting terminal 31 and the line T1. Similarly, the drive voltage VR is applied to each node c2 from a corresponding one of the variable voltage sources 33R. Let the area 100L be an area around the node c1 of the 100, and the area 100R be an area around the node c2. The area (200L) of the electro-optical layer 200 corresponding to the area 100L provides a tone level according to the drive voltage VL, and the area (200R) of the electro-optical layer 200 corresponding to the area 100R provides a tone level according to the drive voltage VR. The area (e.g., the area 200M corresponding to the area 100M of the anode 100) of the electro-optical layer 200 between the nodes c1 and c2 provides a tone level according to the potential difference between the drive voltages VL and VR and the resistance r of the anode 100 (tone level between the tone levels of the adjacent areas 200L and 200R).

With this structure, advantages similar to those of the first embodiment can be achieved. An image where the tone level changes smoothly according to the voltage distribution in an area sandwiched by the nodes c1 and c2) is represented. Since the anode 100 is continuous over the entire substrate 10, there are no portions where the tone level changes discontinuously. Compared with the case where anodes are separated according to each electro-optical element or predetermined range, high-resolution tone-level representation can be implemented using the same number of variable voltage sources 33.

### D. Modifications

Various modifications can be added to the above embodiments. Specific modifications will be described below by way of example. The following modifications may be combined as needed.

### (1) First Modification

Although the case in which three electro-optical elements E are driven by two variable voltage sources 33 has been described in the first and second embodiments, at least four electro-optical elements E may be driven by two variable voltage sources 33 (that is, at least two electro-optical elements are connected to a path connecting the node b1 to the node b2).

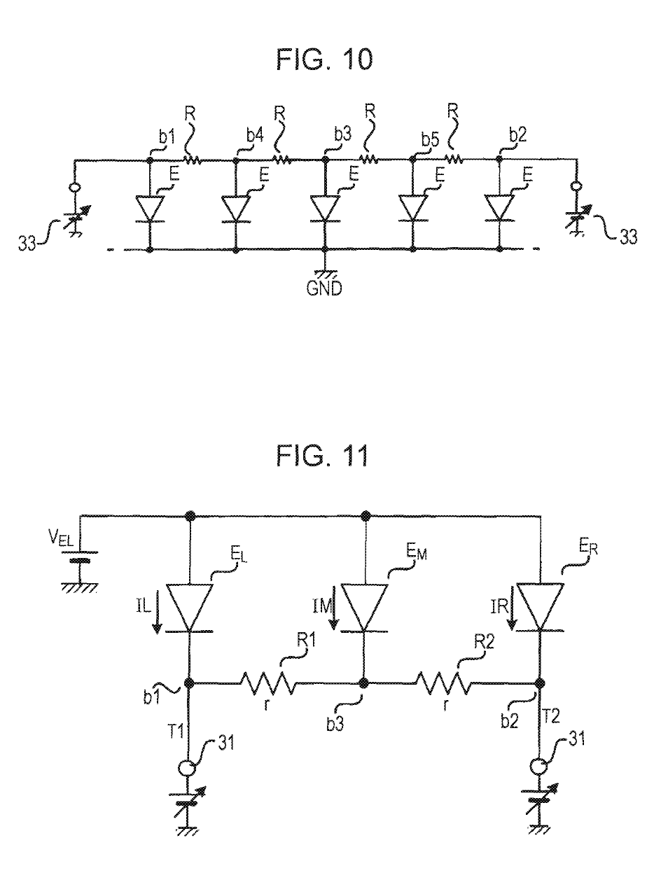

FIG. 10 shows the electrical structure of one element group Gi according to a first modifications. As shown in FIG. 10, one electro-optical element E is connected to each of the nodes b1 and b2 to which voltages are applied from the corresponding variable voltage sources 33 and each of nodes b3, b4, and b5 on the path connecting the node b1 to the node b2. Resistors R are provided between the adjacent nodes b1 to b5. With this structure, two electro-optical elements E at two ends of a sequence of five electro-optical elements E emit light with tone levels according to the voltages applied to the nodes b1 and b2 from the corresponding variable voltage sources 33. The remaining three electro-optical elements E at the center of the sequence emit light with tone levels according to voltages between the voltage at the node b1 and the voltage at the node b2. According to the first modification, advantages similar to those of the first and second embodiments can be achieved. Since more than three electro-optical elements E are driven using two variable voltage sources 33, the resolution can be further increased. At the same time, the number of variable voltage sources 33 can be reduced without reducing the resolution. Accordingly, the size and power consumption of the device can be reduced.

### (2) Second Modification

In the above embodiments, the voltage at the anode of each electro-optical element E has been controlled. Alternatively, the voltage at the cathode of each electro-optical element E may be controlled according to the tone level.

FIG. 11 shows the electrical structure of one element group Gi according to a second modification. As shown in FIG. 11, a power supply voltage VEL is commonly supplied from a constant voltage source to the anodes of the electro-optical elements EL, EM, and ER. In contrast, the variable voltage source 33L is connected to the cathode of the electro-optical element EL, and the variable voltage source 33R is connected to the cathode of the electro-optical element ER. Each of the drive voltages VL and VR applied from the variable voltage sources 33L and 33R is controlled to be one of the voltage values V[0] to V[7] (=VEL) according to the tone level specified thereto. In the case that the drive voltages VL and VR are set to the voltage value V[7] and hence the voltage between the anode and the cathode is zero, the electro-optical elements EL and ER provide the lowest tone level (turned off). The lower the drive voltages VL and VR, the higher the tone level. The resistor R1 is placed between the nodes b1 and b3, and the resistor R2 is placed between the nodes b2 and b3. The drive voltage VM, which is determined on the basis of the voltage values of the drive voltages VL and VR and the resistance r of the resistors R1 and R2, is applied to the cathode of the electro-optical element EM. In this manner, the electro-optical element EM provides a tone level according to the potential difference between the power supply voltage VEL and the drive voltage VM. According to the second modifications, advantages similar to those of the above embodiments can be achieved.

Although not shown in the drawings, in the structure shown in FIGS. 8 and 9 (third embodiment), the common constant voltage source VEL may be supplied to the anode 100, and the drive voltages VL and VR may be supplied from the variable voltage sources 33L and 33R to the nodes c1 and c2 connected to the cathode 300. In this case, advantages similar to those of the third embodiment can be achieved.

### (3) Third Modification

In the above embodiments, the IC chip 30 is COG-mounted on the substrate 10. Alternatively, the IC chip 30 may be COF-mounted on the flexible substrate 50. In this manner, the definition or resolution of the electro-optical elements E can be improved while reducing the number of output terminals of the flexible substrate 50 and the number of mounting terminals of the substrate 10 (terminals of the substrate 10 facing the output terminals of the flexible substrate 50). Instead of using the IC chip 30, a drive circuit (variable voltage sources 33) may be constructed using transistors embedded on the surface of the substrate 10 (e.g., TFTs each having low-temperature polysilicon as a semiconductor layer). With this structure, only two lines are needed to connect the drive circuit to the electro-optical elements E. Compared with the known structure where one line is provided for each electro-optical element E, the resolution of the electro-optical elements E can be improved while maintaining the reliability of connection between the electro-optical elements E and the drive circuit. Since the number of lines is reduced, the electro-optical device becomes smaller.

### (4) Fourth Modification

In the above embodiments, the voltage values of the drive voltages VL and VR are changed according to the tone levels specified to the electro-optical elements E. Alternatively, a tone-level control may be performed using a pulse width modulation (PWM) scheme. The drive voltage VL in the PWM scheme is an on-voltage (voltage for allowing the electro-optical element EL to emit light) in a period according to the tone level specified to the electro-optical element EL within a predetermined unit period and is an off-voltage (voltage turning off the electro-optical element EL) in the remaining period. Therefore, the electro-optical element EL emits light with a time density according to the tone level. The same applies to the relationship between the tone level of the electro-optical element ER and the drive voltage VR. In a period during which both the drive voltages VL and VR are the on-voltage, the drive voltage VM that is lower than the on-voltage by the resistance r is applied to the electro-optical element EM. In a period during which one of the drive voltages VL and VR is the on-voltage, the drive voltage that has a voltage value between the voltage value of the on-voltage and the ground potential GND is applied to the electro-optical element EM. Therefore, the electro-optical element EM is controlled to provide a tone level between those of the electro-optical elements EL and ER or the same tone level as that of the electro-optical elements EL and ER.

### (5) Fifth Modification

In the above embodiments, the tone level of each electro-optical element E is controlled according to a voltage signal (drive voltage VL or VR) output from a corresponding one of the variable voltage sources 33. Alternatively, instead of the variable voltage sources 33, variable current sources that output current signals having current values according to the tone levels of the electro-optical element EL and ER may be employed. In the case that current signals are supplied to the nodes b1 and b2 in the first and second embodiments, a shunt current of each of the current signals is supplied via the node b3 to the electro-optical element EM. In the case that current signals are supplied to the nodes c1 and c2 in the third embodiment, the electro-optical layer 200 provides tone levels in accordance with a current distribution in the area between the nodes c1 and c2. Therefore, advantages similar to those of the above embodiments can be achieved in the fifth modification.

### E. Application

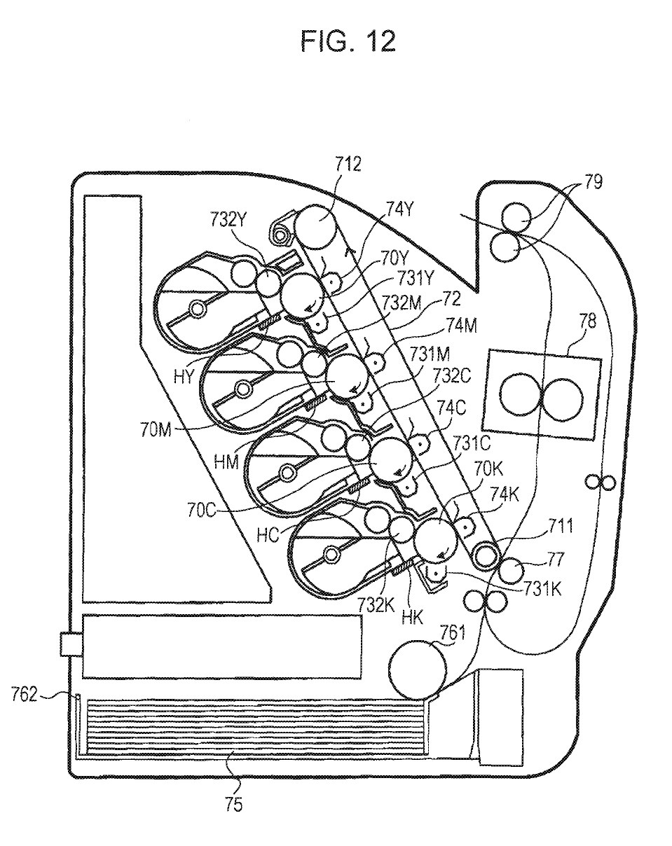

Next, an image forming apparatus will be described by way of example as an electronic apparatus using the electro-optical device according to embodiments of the invention. FIG. 12 is a sectional view of the structure of an image forming apparatus using the electro-optical devices H according to the above embodiments as exposure heads. The image forming apparatus is a tandem full-color image forming apparatus and includes four electro-optical devices H(HK, HC, HM and HY) according to the above embodiments and four photosensitive drums 70 (70K, 70C, 70M, and 70Y) corresponding to the four electro-optical devices H, respectively. Each of the electro-optical devices H is placed facing an image forming surface (peripheral surface) of a corresponding one of the photosensitive drums 70. The subscripts “K”, “C”, “M”, and “Y” of the reference numerals mean that the elements are used to develop black (K), cyan (C), magenta (M), and yellow (Y) images.

As shown in FIG. 12, an endless intermediate transfer belt 72 is wound around a drive roller 711 and a driven roller 712. The four photosensitive drums 70 are arranged near the intermediate transfer belt 72 at predetermined intervals. The photosensitive drums 70 rotate in synchronization with the driving of the intermediate transfer belt 72.

Besides the electro-optical devices H, corona charging units 731 (731K, 731C, 731M, and 731Y) and developing units 732 (732K, 732C, 732M, and 732Y) are arranged near the corresponding photosensitive drums 70. Each of the corona charging units 731 uniformly charges the image forming surface of a corresponding one of the photosensitive drums 70. An electrostatic latent image is formed by exposing the charged image forming surface to light using each electro-optical device H. Each of the developing units 732 then develops an image (visible image) on the corresponding one of the photosensitive drums 70 by allowing a developer (toner) to be adhered to the electrostatic latent image.

The black, cyan, magenta, and yellow images developed on the photosensitive drums 70 are sequentially transferred onto the surface of the intermediate transfer belt 72 (first transfer), thereby developing a full-color image. Four first transfer corotrons (transfer units) 74 (74K, 74C, 74M, and 74Y) are arranged inside the intermediate transfer belt 72. Each of the first transfer corotrons 74 electrostatically absorbs the developed image from a corresponding one of the photosensitive drums 70 and transfers the developed image to the intermediate transfer belt 72 passing between the photosensitive drum 70 and the first transfer corotron 74.

Sheets (recording media) 75 are fed one at a time by a pickup roller 761 from a sheet feeding cassette 762 and transported to the nip between the intermediate transfer belt 72 and a second transfer roller 77. The full-color image developed on the surface of the intermediate transfer belt 72 is transferred to one side of the sheet 75 (second transfer) by the second transfer roller 77, and then fused onto the sheet 75 by allowing the sheet 75 to pass through a fusing roller pair 78. A paper-expelling roller pair 79 expels the sheet 75 on which the developed image has been fused in the above steps.

Because the image forming apparatus described above uses the organic light-emitting diodes as light sources (exposure devices), the size of the image forming apparatus becomes smaller than the size of an image forming apparatus using a laser scanning optical system. The invention is additionally applicable to image forming apparatuses with structures other than the above exemplary structure. For example, the electro-optical device according to embodiments of the invention is applicable to a rotary developing image forming apparatus, an image forming apparatus that directly transfers an image developed on each photosensitive drum to a sheet without using an intermediate transfer belt, and an image forming apparatus that forms a monochrome image.

The use of the electro-optical device according to embodiments of the invention is not limited to exposing an image supporting member. For example, the electro-optical device according to embodiments of the invention is applied in an image scanning apparatus as a line optical head (illuminating device) for illuminating an object to be scanned, such as a document. This type of image scanning apparatus includes a scanner, a scanning section of a copier and a facsimile machine, a barcode reader, and a two-dimensional image code reader that reads a two-dimensional image code, such as a QR code®.

What is claimed is:

1. An electro-optical device comprising:
a first electro-optical element, a second electro-optical element, and a third electro-optical element;
a first node electrically connected to the first electro-optical element;
a second node electrically connected to the second electro-optical element;
a third node electrically connected to the third electro-optical element;
a first resistor placed between the first node and the third node;
a second resistor placed between the second node and the third node;
a first signal supplying unit that supplies a first signal to the first node; and
a second signal supplying unit that supplies a second signal to the second node.

2. The electro-optical device according to claim 1, in a case that a lowest tone level is specified to the first electro-optical element and a higher tone level is specified to the second electro-optical element, the first signal supplying unit supplying either (1) a signal allowing the third electro-optical element to provide a tone level between a first tone level of the first electro-optical element and a second tone level of the second electro-optical element or (2) a signal allowing the third electro-optical element to provide the lowest tone level to the first node.

3. The electro-optical device according to claim 1, further comprising:
a first terminal placed on a substrate and electrically connected to the first node;
a second terminal placed on the substrate and electrically connected to the second node; and
an electronic component mounted on the substrate, the electronic component including a first output terminal connected to the first terminal and a second output terminal connected to the second terminal, the signal from the first signal supplying unit being input to the first output terminal, and the signal from the second signal supplying unit being input to the second output terminal.

4. An electro-optical device comprising:
a continuous electrode including a first node and a second node, the first node and the second node being separated from each other;
a first signal supplying unit that supplies a first signal to the first node;
a second signal supplying unit that supplies a second signal to the second node, the second signal being set independent of the first signal; and
an electro-optical layer that provides a tone level according to a voltage or current distribution in a plane of the electrode.

5. An electro-optical device comprising:
a first electro-optical element, a second electro-optical element, and a third electro-optical element;
a first node that supplies a first voltage signal to the first electro-optical element;
a second node that supplies a second voltage signal to the second electro-optical element; and
a third node placed between the first node and the second node, the third node dividing and supplying the first voltage signal and the second voltage signal to the third electro-optical element.

6. An electro-optical device comprising:
a first electro-optical element, a second electro-optical element, and a third electro-optical element;
a first node that supplies a first current signal to the first electro-optical element;
a second node that supplies a second current signal to the second electro-optical element; and
a third node placed between the first node and the second node, the third node supplying a shunt current of each of the first current signal and the second current signal to the third electro-optical element.

7. An image forming apparatus comprising:
a housing; and
an electro-optical device as set forth in claim 1 accommodated by the housing.

8. An electro-optical device comprising:
a plurality of electro-optical elements in a consecutive order, each electro-optical element being electrically connected to an adjacent electro-optical element by a resistor;
a first signal supplying unit that supplies a first signal to a first electro-optical element in the consecutive order of the electro-optical elements; and
a second signal supplying unit that supplies a second signal to a last electro-optical element in the consecutive order of the electro-optical elements.
